(19) United States
(12) Patent Application Publication
(10) Pub. No.: US 2014/0019650 A1
(43) Pub. Date: Jan. 16, 2014

(54) Multi-Write Bit-Fill FIFO

(71) Applicants: Zhi Bin Li, Shanghai (CN); Zhiwei Wu, Shanghai (CN)

(72) Inventors: Zhi Bin Li, Shanghai (CN); Zhiwei Wu, Shanghai (CN)

(21) Appl. No.: 13/545,833

(22) Filed: Jul. 10, 2012

(51) Int. Cl. G06F 5/12

(52) U.S. Cl. 710/53

(57) ABSTRACT

Various embodiments of the present invention are related to memory buffers, and in particular to a multi-write bit-fill FIFO to which multiple addresses may be written simultaneously and which fills in bit spaces as data blocks are written.

### BACKGROUND

Buffers are memory circuits that may be used to temporarily store information in electronic data processing systems, for example to change the format or length of data produced by one component so that it can be used by the next in the data processing system. One such buffer is a synchronous barrel shift buffer 100 as illustrated in FIG. 1 that may be used in a magnetic hard disk drive. The barrel shift buffer 100 temporarily stores data between encoders as a data sector is prepared for writing to the disk, adapting a variable length output from a first encoder to a fixed length input to a second encoder.

The barrel shift buffer 100 accepts data from one or more input data sources 102, 104, 106 in a variety of formats. The input data sources 102, 104, 106 may be, for example, a data encoder with a number of operating modes, or multiple selectable encoders. A first data source 102 provides 145-bit data blocks at a data signal 110, unless at the end of the data sector, in which case the sector end signal 112 is asserted and a data block is provided at data signal 110 with a width anywhere between 0 and 145 bits long. A width indicator signal 114 indicates the number of bits in the data block at data signal 110 when the sector end signal 112 is asserted. A second data source 104 provides 97-bit data blocks at a data signal 120, unless at the end of the data sector, in which case the sector end signal 122 is asserted and a data block is provided at data signal 120 with a width anywhere between 0 and 97 bits long. A width indicator signal 124 indicates the number of bits in the data block at data signal 120 when the sector end signal 122 is asserted. A third data source 106 provides 16-bit data blocks at a data signal 130, unless at the end of the data sector, in which case the sector end signal 132 is asserted and a data block is provided at data signal 130 with a width anywhere between 0 and 16 bits long. A width indicator signal 134 indicates the number of bits in the data block at data signal 130 when the sector end signal 132 is asserted. The data from either input data source 102, 104, or 106 is selected as input to the barrel shift buffer 100 by multiplexer 140 based on source select signal 142. The data provided to the barrel shift buffer 100 thus can have a wide variety of widths, due both to the different operating modes of an upstream encoder and the variable length data blocks at the end of a data sector.

The example barrel shift buffer 100 can hold up to 512 data bits, with data shifted out on output 144 in 16 bit blocks. A pointer 146 identifies the location of the next 16-bit data block to be shifted out on output 144. For each read operation, a 16-bit data block at the location specified by the pointer 146 is shifted out, and the pointer 146 is moved (or decremented) by 16 bits to the next location. When writing to the barrel shift buffer 100, the pointer 146 is incremented by the number of bits shifted in. For example, if the 145 bit source 102 is selected, and the data block being written is not at the end of a data sector, a 145-bit block is shifted in and the pointer 146 is incremented by 145. If the 145 bit source 102 is selected, and the data block being written is at the end of a data sector, a data block with width specified by width indicator signal 114 is shifted in and the pointer 146 is incremented by the value at width indicator signal 114.

Because the input data from multiplexer 140 is of variable width, and because the output pointer 146 can point at any of the 512 bit locations in the barrel shift buffer 100, the output selector in the barrel shift buffer 100 must be able to read a 16-bit block from any random location. This requires a very large combinational logic block for addressing in the barrel shift buffer 100, with much more space used by combinational logic than by the sequential logic used for shifting and storage.

### BRIEF SUMMARY

Various embodiments of the present invention are related to memory buffers, and in particular to a multi-write bit-fill first-in-first-out (FIFO) memory to which multiple addresses may be written simultaneously and which fills in bit spaces as data blocks are written. Variable-length data blocks to be written in the FIFO are normalized to the maximum expected or allowable length. Data is aligned to the most significant bit (MSB) in the input block with zero-padding added as needed at the least significant bit (LSB) end of the input block to achieve input blocks with uniform length. A word write pointer tracks the next row in the FIFO with free space, and a bit write pointer tracks the next available bit position in the row identified by the word write pointer. As a data block is written, empty bits in the last empty or partially empty row indicated by the word write pointer are filled in the FIFO. A width indicator signal provided with the data block indicates the number of data bits in the data block, excluding any zero padding at the LSB. The number of bits written to the FIFO is controlled by the width indicator signal. If the width indicator signal indicates that the data block is wider than the FIFO row, the data block is written across multiple FIFO rows or addresses automatically. When a data block has been written to the FIFO, the bit write pointer and word write pointer identify the next free bit position in the FIFO by column and row, respectively.

A read pointer identifies the address of the next available FIFO row. During a read operation, the word at the address in the read pointer is output, and the read pointer is incremented.

This summary provides only a general outline of some embodiments according to the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification.

FIG. 1 depicts an example prior art barrel shift buffer;

FIG. 2 depicts a block diagram of a read channel including a multi-write bit-fill FIFO which may be used to store and retrieve or transmit and receive data in accordance with some embodiments of the present inventions;

FIG. 3 depicts a block diagram of a multi-write bit-fill FIFO and input data conditioner in accordance with some embodiments of the present inventions;

FIG. 4 depicts a block diagram of a multi-write bit-fill FIFO in accordance with some embodiments of the present inventions;

FIG. 5 depicts a method for buffering and converting data in accordance with some embodiments of the present inventions;

FIG. 6 depicts a storage system including a multi-write bit-fill FIFO in accordance with some embodiments of the present invention; and

FIG. 7 depicts a wireless communication system including a multi-write bit-fill FIFO in accordance with some embodiments of the present invention.

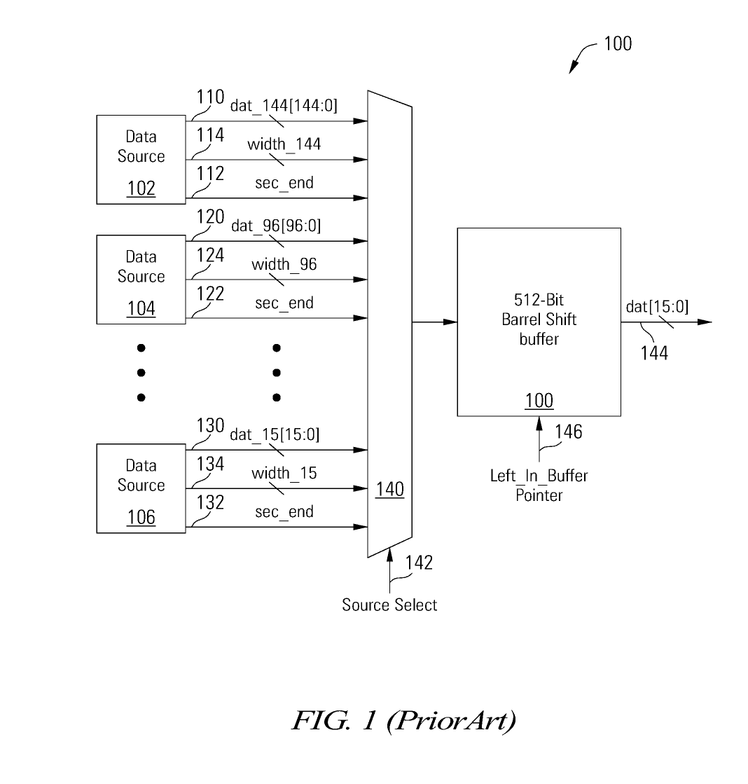

### DETAILED DESCRIPTION OF THE INVENTION

Various embodiments of the present invention are related to memory buffers, and in particular to a multi-write bit-fill FIFO to which multiple addresses may be written simultaneously and which fills in bit spaces as data blocks are written. The multi-write bit-fill FIFO buffers and converts variable length input data blocks to fixed length output words.

Variable-length data blocks to be written in the FIFO are normalized to the maximum expected or allowable length. Data is aligned to the most significant bit (MSB) in the input block with zero-padding added as needed at the least significant bit (LSB) end of the input block to achieve input blocks with uniform length. A word write pointer tracks the next row in the FIFO with free space, and a bit write pointer tracks the next available bit position in the row identified by the word write pointer. As a data block is written, empty bits in the last empty or partially empty row indicated by the word write pointer are filled in the FIFO. A width indicator signal provided with the data block indicates the number of data bits in the data block, excluding any zero padding at the LSB. The number of bits written to the FIFO is controlled by the width indicator signal. If the width indicator signal indicates that the data block is wider than the FIFO row, the data block is written across multiple FIFO rows or addresses automatically. When a data block has been written to the FIFO, the bit write pointer and word write pointer identify the next free bit position in the FIFO by column and row, respectively.

A read pointer identifies the address of the next available FIFO row. During a read operation, the word at the address in the read pointer is output, and the read pointer is incremented.

By normalizing the length of input data blocks, a data block with a variable number of data bits up to a maximum width can easily be stored, filling in empty bit positions in partially filled rows. This allows combinational control logic to be placed on the write side of the FIFO, increasing logic sharing so that the overall size of the FIFO is reduced, and greatly simplifying read operations. The size of the multi-write bit-fill FIFO, and the ratio of combinational logic to sequential logic in the multi-write bit-fill FIFO, are substantially lower than in a conventional barrel shift buffer.

The multi-write bit-fill FIFO may be used to temporarily store and reformat data in any electronic data processing system, including during transmission of information over virtually any channel or storage of information on virtually any media. Transmission applications include, but are not limited to, optical fiber, radio frequency channels, wired or wireless local area networks, digital subscriber line technologies, wireless cellular, Ethernet over any medium such as copper or optical fiber, cable channels such as cable television, and Earth-satellite communications. Storage applications include, but are not limited to, hard disk drives, compact disks, digital video disks, magnetic tapes and memory devices such as DRAM, NAND flash, NOR flash, other non-volatile memories and solid state drives.

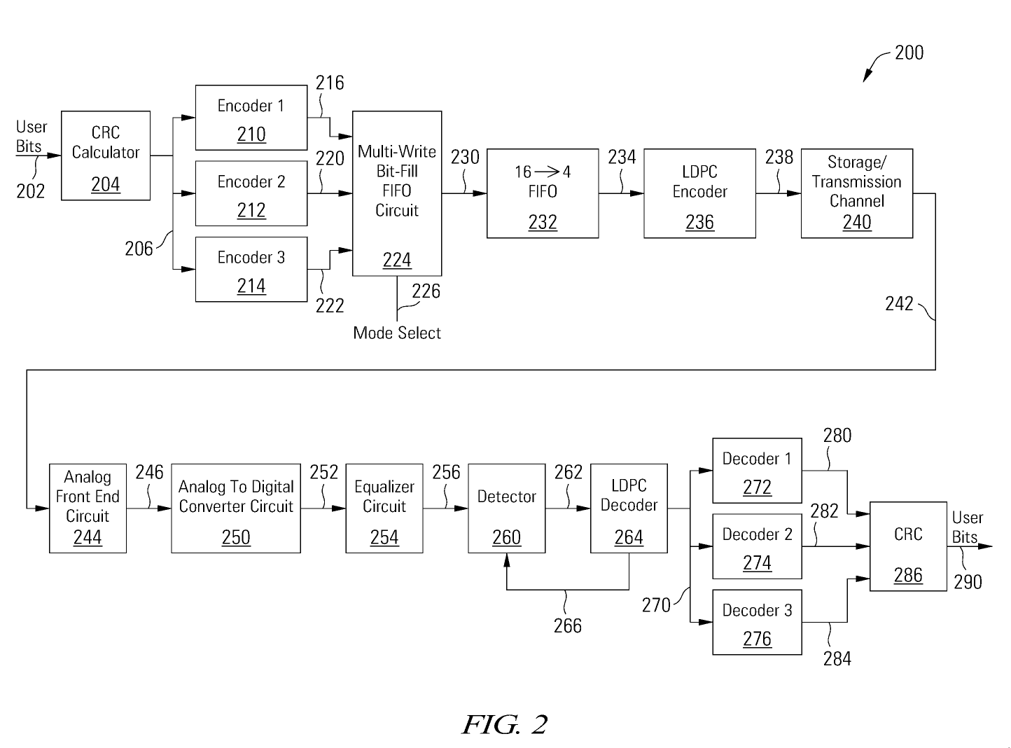

Turning to FIG. 2, as an example application of a multi-write bit-fill FIFO, a read channel 200 is disclosed which can be used to store and retrieve or transmit and receive data in accordance with some embodiments of the present inventions and which includes a multi-write bit-fill FIFO 224. Read channel 200 is used to process digital user data bits 202, store them in or transmit them through a storage or transmission channel 240 and retrieve the user data bits 290 without introducing errors. The user data bits 202 may be processed in a cyclic redundancy check (CRC) calculator 204 that adds error-detection check values to blocks of the user data bits 202, providing a simple technique to detect errors introduced in the user data bits in the read channel 200. The resulting codewords 206 from the CRC calculator 204 may be encoded in one or more data encoders 210, 212, 214 to yield encoded data 216, 220, 222. Data encoders 210, 212, 214 may be an encoder with multiple operating modes or multiple separate selectable data encoders, with one encoder or operating mode being enabled to generate an output data stream. As one example, a data encoder 210 may be an MTR encoder, an enumerative encoder which limits maximum transition run length. The frequency response of the read channel 200 is generally at a maximum at DC and degrades near the Nyquist frequency, particularly when the storage or transmission channel 240 is a magnetic storage device. By limiting the maximum transition run length in the encoded user bits (e.g., 216), the read channel 200 operates below the Nyquist frequency and avoids errors that might be introduced by the degraded frequency response near the Nyquist frequency.

The encoded data 216, 220, 222 from data encoders 210, 212, 214 has variable length data blocks, depending on the encoding algorithm applied and other factors such as whether the data block is at the end of a data sector, limiting the number of data bits in the block. One of the streams of encoded data 216, 220, 222 will be encoded again, for example in a low density parity check (LDPC) encoder 236, which calculates and adds parity bits to the data. In this example, LDPC encoder 236 requires that data be input in 4-bit blocks. A multi-write bit-fill FIFO 224 as disclosed herein is used to buffer and convert the variable-length data blocks in the encoded data 216, 220, 222 from data encoders 210, 212, 214 to 16-bit blocks, which are further divided in 16→4 FIFO 232 for the LDPC encoder 236. In other embodiments, the multi-write bit-fill FIFO 224 may be adapted to yield 4-bit blocks directly for the LDPC encoder 236, or any other width data blocks as desired. The multi-write bit-fill FIFO 224 thus receives an input data stream with variable length blocks at one of encoded data signals 216, 220, 222, and outputs fixed width data blocks at output 230. The standard input data block width may be selected with mode select input 226, although the input data blocks may have any width from 0 up to the selected width if the block is at the end of a data sector. Output 230 is provided to 16→4 FIFO 232, which yields 4-bit data blocks 234 for the LDPC encoder 236.

LDPC encoder 236 produces and multiplexes in parity bits, yielding an encoded data stream 238 that may be further processed or manipulated before storage or transmission in storage or transmission channel 240. For example, the encoded data stream 236 may be converted to analog format and modulated or otherwise processed before it used to drive a magnetic write head or to be transmitted as a radio frequency signal or other wired or wireless signal.

The read channel 200 includes an analog front end circuit 244 that receives and processes an analog signal 242 from the storage or transmission channel 240. Analog front end circuit 244 may include, but is not limited to, an analog filter and an amplifier circuit as are known in the art. Based upon the disclosure provided herein, one of ordinary skill in the art will recognize a variety of circuitry that may be included as part of analog front end circuit 244. In some cases, the gain of a variable gain amplifier included as part of analog front circuit 244 may be modifiable, and the cutoff frequency and boost of an analog filter included in analog front end circuit 244 may be modifiable. Analog front end circuit 244 receives and processes the analog signal 242, and provides a processed analog signal 246 to an analog to digital converter circuit 250. In some cases, analog signal 242 is derived from a read/write head assembly in the storage or transmission channel 240 that is disposed in relation to a storage medium. In other cases, analog signal 242 is derived from a receiver circuit in the storage or transmission channel 240 that is operable to receive a signal from a transmission medium. The transmission medium may be wireless or wired such as, but not limited to, cable or optical connectivity. Based upon the disclosure provided herein, one of ordinary skill in the art will recognize a variety of sources from which analog input 242 may be derived.

Analog to digital converter circuit 250 converts processed analog signal 242 into a corresponding series of digital samples 252. Analog to digital converter circuit 250 may be any circuit known in the art that is capable of producing digital samples corresponding to an analog input signal. Based upon the disclosure provided herein, one of ordinary skill in the art will recognize a variety of analog to digital converter circuits that may be used in relation to different embodiments of the present invention. Digital samples 252 are provided to an equalizer circuit 254. Equalizer circuit 254 applies an equalization algorithm to digital samples 252 to yield an equalized output 256. In some embodiments of the present invention, equalizer circuit 254 is a digital finite impulse response filter circuit as are known in the art. Equalized output 256 is provided to a data detector circuit 260. In some cases, equalizer 254 includes sufficient memory to maintain one or more codewords until a data detector circuit 260 is available for processing.

The data detector circuit 260 performs a data detection process on the received input from the storage or transmission channel 240 resulting in a detected output 262. In some embodiments of the present invention, data detector circuit 142 is a Viterbi algorithm data detector circuit as are known in the art. In other embodiments of the present invention, data detector circuit 142 is a maximum a posteriori data detector circuit as are known in the art. Of note, the general phrases “maximum a posteriori data detection algorithm” or “maximum a posteriori data detector circuit” are used in their broadest sense to mean any maximum a posteriori detection algorithm or detector circuit or variations thereof including, but not limited to, simplified maximum a posteriori data detection algorithm and a max-log maximum a posteriori data detection algorithm, or corresponding detector circuits. Based upon the disclosure provided herein, one of ordinary skill in the art will recognize a variety of data detector circuits that may be used in relation to different embodiments of the present invention.

The detected output 262 is provided to a decoder such as an LDPC decoder 264 which performs parity checks on the detected output 262, ensuring that parity constraints established by the LDPC encoder 236 are satisfied in order to detect and correct any errors that may have occurred in the data while passing through the storage or transmission channel 240 or other components of the read channel 200. Other error detection and correction encoders and decoders may be used in the read channel 200 in place of the LDPC encoder 236 and LDPC decoder 264, and one of ordinary skill in the art will recognize a variety of error detection and correction encoders and decoders that may be used in relation to different embodiments of the present invention. In the case of the LDPC encoder 236 and LDPC decoder 264, the data detector circuit 260 and LDPC decoder 264 may operate in an iterative fashion, with an LDPC output 264 passed from the LDPC decoder 264 to the data detector circuit 260 to aid in the data detection and parity check process. The LDPC decoder 264 yields encoded user bits 270 retrieved from the storage or transmission channel 240, with the parity bits removed after the combination of encoded user bits and parity bits satisfy the parity check constraints.

The encoded user bits 270 from the LDPC decoder 264 are provided to one or more decoders 272, 274, 276, for example including an MTR decoder, which reverse the encoding performed by encoders 210, 212, 214. The one or more decoders 272, 274, 276 yield CRC codewords 280, 282, 284 which are provided to CRC circuit 286 to perform CRC error checking If one decoder is provided in place of illustrated decoders 272, 274, 276 is provided, a single output will be provided to CRC circuit 286. If multiple decoders 272, 274, 276 are provided, one of outputs 280, 282, 284 will be selected to provide codewords to CRC circuit 286. The CRC circuit 286 yields user data bits 290, which should be identical to user data bits 202 if the data is not corrupted in the storage or transmission channel 240 beyond the capacity of the data detector circuit 260 and LDPC decoder 264 to correct.

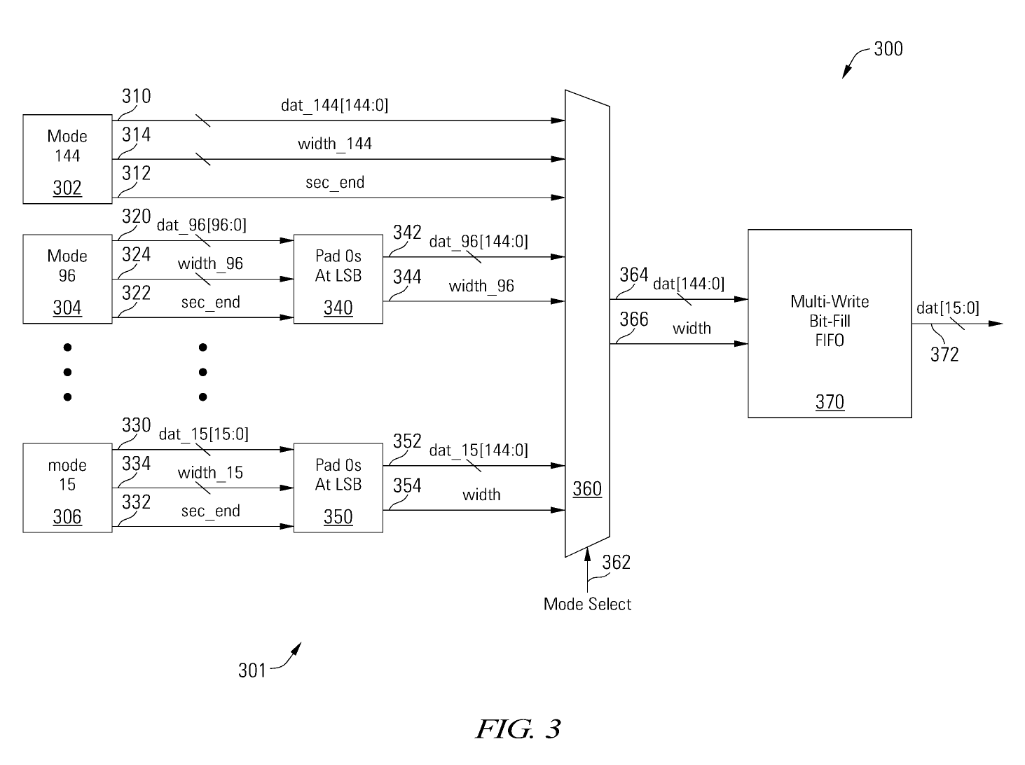

Turning to FIG. 3, a data processing system 300 including a multi-write bit-fill FIFO 370 and input data conditioner 301 is depicted in accordance with some embodiments of the present inventions. Data blocks to be written may be obtained from one or more sources 302, 304, 306, such as a data encoder with multiple encoding modes or from multiple encoders or other sources. In the example disclosed in FIG. 3, at least three sources 302, 304, 306 are included, providing data in mode 144 which provides between 0 and 145 bit data blocks, mode 96 which provides between 0 and 97 bit data blocks, and mode 15 which provides between 0 and 16 bit data blocks. Input data blocks from sources 302, 304, 306 are normalized in input data conditioner 301, which yields 145-bit data blocks at output 364. Input data blocks from sources 302, 304, 306 are located at the MSB end of the 145-bit data blocks at output 364, with the LSB end zero-padded.

Data blocks at up to 145 bits wide from source 302 are provided on the 145-bit dat_{—}144 bus 310, unless a corresponding sec_end signal 312 is asserted, indicating that the data block is at the end of a data sector. When the sec_end signal 312 is asserted, the width or number of bits in the data block on the 145-bit dat_{—}144 bus 310 is indicated by the width_{—}144 signal 314. The unused bits at the LSB end of the 145-bit dat_{—}144 bus 310 are set to zero when the data block contains less than 145 bits, as indicated by the width_{—}144 signal 314.

Data blocks at up to 97 bits wide from source 304 are provided on the 97-bit dat_{—}96 bus 320, unless a corresponding sec_end signal 322 is asserted, indicating that the data block is at the end of a data sector. When the sec_end signal 322 is asserted, the width or number of bits in the data block on the 97-bit dat_{—}96 bus 320 is indicated by the width_{—}96 signal 324. The unused bits at the LSB end of the 97-bit dat_{—}96 bus 320 are set to zero when the data block contains less than 97 bits, as indicated by the width_{—}96 signal 324. The 97-bit dat_{—}96 bus 320 is converted to a 145-bit data bus 342 by zero-padding circuit 340, which sets the extra 48 bits at the LSB end of the 145-bit data bus 342 to zero. The corresponding width_{—}96 signal 344 will report the data block width at the width_{—}96 signal 324, plus 48 for new bits added by zero-padding circuit 340.

Data blocks at up to 16 bits wide from source 306 are provided on the 16-bit dat_{—}15 bus 330, unless a corresponding sec_end signal 332 is asserted, indicating that the data block is at the end of a data sector. When the sec_end signal 332 is asserted, the width or number of bits in the data block on the 16-bit dat_{—}15 bus 330 is indicated by the width_{—}15 signal 334. The unused bits at the LSB end of the 16-bit dat_{—}15 bus 330 are set to zero when the data block contains less than 16 bits, as indicated by the width_{—}15 signal 334. The 16-bit dat_{—}15 bus 330 is converted to a 145-bit data bus 352 by zero-padding circuit 350, which sets the extra 129 bits at the LSB end of the 145-bit data bus 352 to zero. The corresponding width signal 354 will report the data block width at the width_{—}15 signal 334, plus 129 for new bits added by zero-padding circuit 350.

Multiplexer 360 selects between data buses 310, 342 or 352 based on mode select signal 362, with their accompanying width signals 314, 344 or 354, yielding output data bus 364 and width signal 366. The input data conditioner 301 thus generates a 145-bit output 364, with between 0 and 145 data bits contained in a data block on the 145-bit output 364, and with the number of data bits on the 145-bit output 364 reported by the width signal 366. The input data conditioner 301 converts all input data blocks to the maximum expected or allowed width, zero-padding the empty least significant bits. Notably, the input and output data block widths from input data conditioner 301 are examples and may be any suitable values. Furthermore, the normalization and zero-padding performed in input data conditioner 301 may be performed in circuits external to multi-write bit-fill FIFO 370, as illustrated in FIG. 3, or may be incorporated in the multi-write bit-fill FIFO 370.

The multi-write bit-fill FIFO 370 receives the variable-width 145-bit input data blocks 364, and the width signal 366, writing one or more addresses or rows in the multi-write bit-fill FIFO 370 for each data block on bus 364, beginning with the first empty bit location. The multi-write bit-fill FIFO 370 yields 16-bit words at output 372, with each bit of output 372 containing data at every read operation.

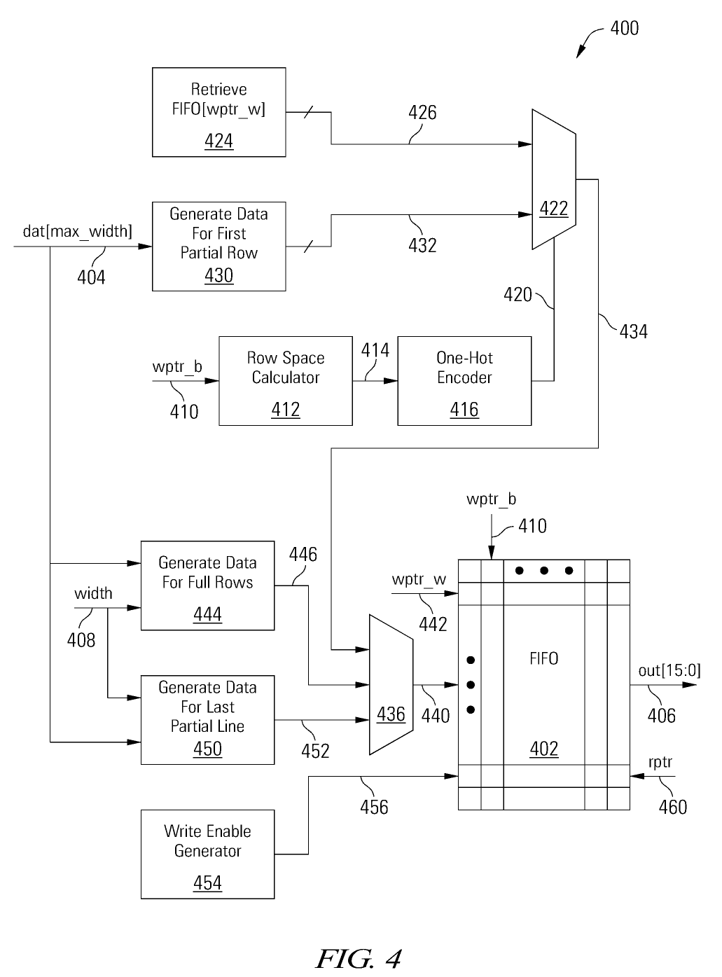

Turning to FIG. 4, a multi-write bit-fill FIFO 400 is depicted in accordance with some embodiments of the present inventions. A FIFO memory 402 is written in bit-fill fashion, with empty bit positions in partially empty rows filled before moving on to empty rows. Multiple rows can be written simultaneously when the data block on input data bus 404 is wider than a row of the FIFO 402. In some embodiments, the FIFO 402 is 16 bits wide and 32 rows deep, for a 512-bit capacity. Data is read from the FIFO 402 on 16-bit output data bus 406.

A bit write pointer 410 tracks the next empty bit position in a current row of the FIFO 402. A word write pointer wptr_w 442 tracks the current row of the FIFO 402. During a write operation, if the current row of the FIFO 402 (identified by word write pointer wptr_w 442) contains some existing data and is partially empty, a row space calculator 412 calculates the number of empty bit positions in the current row. The row space calculator 412 calculates the free space wptr_space[3:0] 414 as wptr_space[3:0]=(16-wptr_b), where wptr_b 410 is the bit or column position of the first empty bit, and 16 is the width of the FIFO 402. For example, if columns 0-13 of the current row contain existing data bits, and columns 14 and 15 are empty, wptr_b 410 will be 14, and wptr_space[3:0] will be 2 (or 010 binary). A one-hot encoder 416 converts the wptr_b 410 to a 16-bit signal wr_en_residual[15:0] 420 with one bit turned on, identifying the insertion point for new data. Existing data in the row in FIFO 402 to the left of the insertion point will be maintained, while the two empty bits to the right of the insertion point will contain the two most significant bits of the data block at input data bus 404.

The data bits to be written to the empty bit positions in the current row are derived from input data bus 404 in data generator 430 by pulling the number of bits specified by wptr_space[3:0] 414 from the data block on input data bus 404 to generate up to a 16-bit data word 432. For example, data generator 430 may implement the operation (dat[144:129]>>wptr_b), right shifting the most significant 16 bits from input data bus 404 by the number of filled bit positions in the current row of the FIFO 402. The existing data FIFO[wptr_w] in the current row (identified by word write pointer wptr_w 442) of FIFO 402 is retrieved in retrieval circuit 424 to yield 16-bit signal data 426. Multiplexer 422 merges the new data bits 432 with the existing data FIFO[wptr_w] 426, with the new bits on the right and the existing bits in their current positions on the left of the current row, to yield new data 434 to be written to the current row identified by word write pointer wptr_w 442. In other words, the shifted input data bits from data generator 430 are concatenated to the right end of existing data bits in the current row in multiplexer 422, with the one-hot select signal wr_en_residual[15:0] 420 indicating the division between existing data bits on the left and the new data bits on the right. Based upon the disclosure provided herein, one of ordinary skill in the art will recognize a variety of circuitry that may be used to fill the empty bit positions of the current row with data bits from input data bus 404.

If more data bits are available to be written from the data block at input data bus 404, they are written to subsequent rows in the FIFO 402, filling the rows if enough bits are available, and zero-padding the last row to be written if the data bits from input data bus 404 do not completely fill it. The data to be written can be derived from input data bus 404 by data generator 444 which generates the data for full FIFO rows, or by data generator 450, which generates the data for a last partially filled FIFO row and zero-fills the unused bits of the row. The data may be derived from input data bus 404 in data generators 444 and 450 by implementing the operation wr_dat_new[144:0]=(dat[144:0]<<wptr_space), in other words left shifting out the bits stored in the first row as generated in data generator 430 to store the remaining bits to write in wr_dat_new[144:0]. The number i of full rows needed to store the remaining bits in wr_dat_new[144:0] can be calculated by finding the largest integer i for which the equation (width−wptr_space>16*i) is true, where width 408 is the number of data bits in the data block at input data bus 404, wptr_space is the number of free bits in the first row as calculated by row space calculator 412, 16 is the example width of the FIFO 402, and i is the number of full rows required to write the data block.

For example, if a 145-bit data block is received at input data bus 404, and two bits are free in the first row identified by word write pointer wptr_w 442 as in the example above so that wptr_space=2, the equation (width−wptr_space>16*i) becomes (145−2>16*i), and 8 is the largest value of i for which the equation is true. Thus, 8 full rows of FIFO 402 will be needed to store the 145-bit data block is received at input data bus 404, with each 16-bit segment pulled from wr_dat_new[144:0] by data generator 444 to yield a series of 8 16-bit words at output 446 to be written to FIFO 402.

The data to be written to the last partial row in FIFO 402 may be generated in data generator 450, which prepares a 16-bit word at output 452 containing, in this example, the last 15 bits of the 145-bit data block received at input data bus 404. These bits may be obtained by left shifting the bits from wr_dat_new[144:0] as in data generator 450, and filling the remaining empty bits with zeroes. In other embodiments, the 16-bit words to be written, including the last, may be generated in one data generator (e.g., 450).

The 16-bit words to be written to the FIFO 402 based on the data block at input data bus 404 are provided on signals 434, 446 and 452, generated using data generators 430, 450 and 454, and may be selected for writing in multiplexer 436, yielding input 440 to FIFO 402. Based upon the disclosure provided herein, one of ordinary skill in the art will recognize a variety of circuitry that may be used to generate the 16-bit words to be written to the FIFO 402 based on the data block at input data bus 404, first filling the available bits in the current row identified by word write pointer wptr_w 442 and the column identified by bit write pointer 410.

At the end of the write operation, the bit write pointer 410 and word write pointer wptr_w 442 are left pointing at the next available bit position and row. The word write pointer wptr_w 442 will point at the last row written, if at least one bit position was unused, or at the next row if all bits were used in the last row written. The next position of the bit write pointer 410 may be calculated using the operation wptr_b_next=(width−wptr_space−16*i), where width 408 is the number of data bits in the data block at input data bus 404, wptr_space is the number of free bits in the first row as calculated by row space calculator 412, 16 is the example width of the FIFO 402, and i is the number of full rows required to write the data block. With the example presented above, in which width=145, wptr_space=2, and i=8, wptr_b_next=(145−2−16*8)=15, pointing at the last column in columns 0-15 of FIFO 402.

In some embodiments, a write enable signal 456 may be produced by a write enable generator 454, for example based on the word write pointer wptr_w 442 and the variable i, enabling writes to each of the rows in FIFO 402 to receive new data based on the data block at input data bus 404.

During a read operation, the 16-bit word identified by read pointer 460 is yielded at output 406 and the read pointer 460 is incremented. The memory locations just read may be marked as empty in some embodiments, allowing subsequent write operations to fill the locations. In both read and write operations, the pointers 410, 442 and 460 may wrap around in the FIFO 402 when the last bit position in the FIFO 402 is reached.

The functions performed by the circuit blocks disclosed in FIG. 4 may alternatively be performed by any suitable arrangement of circuits or code. In some embodiments, the multi-write bit-fill FIFO 400 may be implemented using a hardware description language such as Verilog or VHDL and embodied in an integrated circuit. The equations above are examples only and may be adapted or adjusted as desired to implement the multi-write bit-fill FIFO disclosed herein.

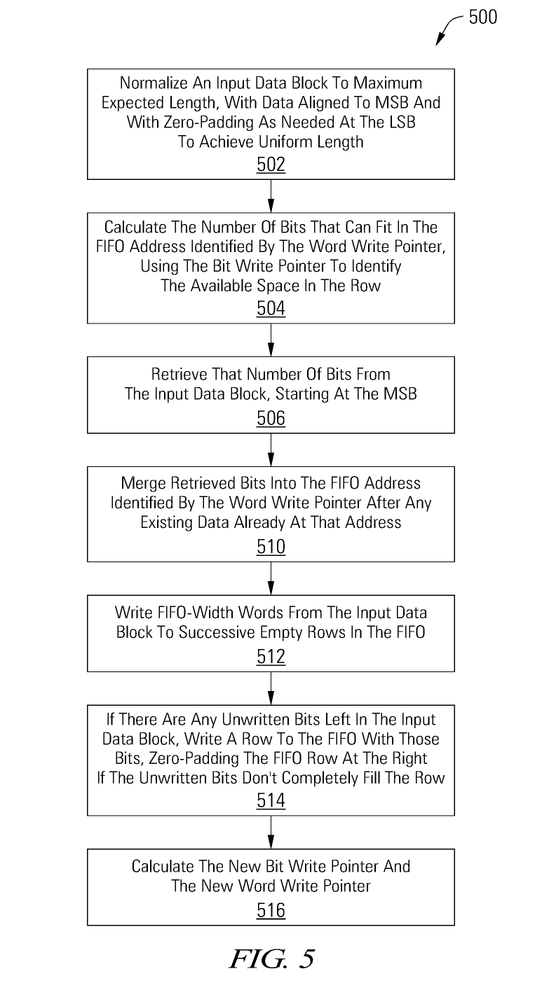

Turning to FIG. 5, a flow diagram 500 depicts a method for buffering and converting data in a multi-write bit-fill FIFO such as that of FIGS. 3 and 4. Following flow diagram 500, a variable length input data block is normalized to the maximum expected length, with data bits aligned to the MSB and with zero-padding as needed at the LSB to achieve uniform length. (Block 502) The number of bits is calculated that can fit in the FIFO address identified by the word write pointer, using the bit write pointer to identify the available space in the row. (Block 504) That number of bits is retrieved from the input data block, starting at the MSB. (Block 506) The retrieved bits are merged into the FIFO address identified by the word write pointer after any existing data already at that address, at the location identified by the bit write pointer. (Block 510) FIFO-width words from the input data block are written to successive empty rows in the FIFO. (Block 512) If there are any unwritten bits left in the input data block, those bits are written to the next row of the FIFO, zero-padding the FIFO row at the right if the unwritten bits don't completely fill the row. (Block 514) The new bit write pointer and the new word write pointer are calculated so that the next write operation will start at the next available bit position. (Block 516)

The method illustrated in FIG. 5 is not limited to the order disclosed, and one or more of the operations may be performed in parallel. The method of buffering and the multi-write bit-fill FIFO is also not limited to the example left-to-right, top-to-bottom writing and LSB-side zero padding disclosed herein. The multi-write bit-fill FIFO is also not limited to any particular maximum input data block width, or to any particular width or depth, and the values disclosed and illustrated herein are merely examples.

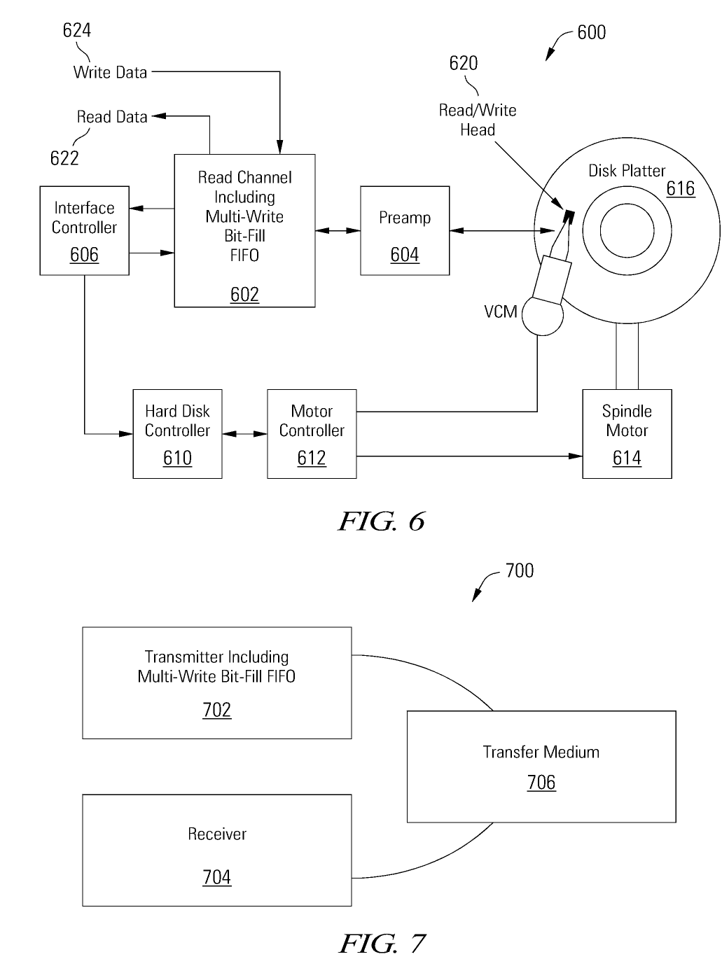

Although the multi-write bit-fill FIFO disclosed herein is not limited to any particular application, several examples of applications are illustrated in FIGS. 6 and 7 that benefit from embodiments of the present invention. Turning to FIG. 6, a storage system 600 is illustrated as an example application of a multi-write bit-fill FIFO in accordance with some embodiments of the present inventions. The storage system 600 includes a read channel circuit 602 with a multi-write bit-fill FIFO in accordance with some embodiments of the present invention. Storage system 600 may be, for example, a hard disk drive. Storage system 600 also includes a preamplifier 604, an interface controller 606, a hard disk controller 610, a motor controller 612, a spindle motor 614, a disk platter 616, and a read/write head assembly 620. Interface controller 606 controls addressing and timing of data to/from disk platter 616. The data on disk platter 616 consists of groups of magnetic signals that may be detected by read/write head assembly 620 when the assembly is properly positioned over disk platter 616. In one embodiment, disk platter 616 includes magnetic signals recorded in accordance with either a longitudinal or a perpendicular recording scheme.

In a typical read operation, read/write head assembly 620 is accurately positioned by motor controller 612 over a desired data track on disk platter 616. Motor controller 612 both positions read/write head assembly 620 in relation to disk platter 616 and drives spindle motor 614 by moving read/write head assembly 620 to the proper data track on disk platter 616 under the direction of hard disk controller 610. Spindle motor 614 spins disk platter 616 at a determined spin rate (RPMs). Once read/write head assembly 620 is positioned adjacent the proper data track, magnetic signals representing data on disk platter 616 are sensed by read/write head assembly 620 as disk platter 616 is rotated by spindle motor 614. The sensed magnetic signals are provided as a continuous, minute analog signal representative of the magnetic data on disk platter 616. This minute analog signal is transferred from read/write head assembly 620 to read channel circuit 602 via preamplifier 604. Preamplifier 604 is operable to amplify the minute analog signals accessed from disk platter 616. In turn, read channel circuit 602 decodes and digitizes the received analog signal to recreate the information originally written to disk platter 616. This data is provided as read data 622 to a receiving circuit. A write operation is substantially the opposite of the preceding read operation with write data 624 being provided to read channel circuit 602. This data is then encoded and written to disk platter 616. As part of encoding the data, read channel circuit 602 processes the data using a multi-write bit-fill FIFO. Such a multi-write bit-fill FIFO may be implemented consistent with that disclosed above in relation to FIGS. 3-4.

It should be noted that storage system 600 may be integrated into a larger storage system such as, for example, a RAID (redundant array of inexpensive disks or redundant array of independent disks) based storage system. Such a RAID storage system increases stability and reliability through redundancy, combining multiple disks as a logical unit. Data may be spread across a number of disks included in the RAID storage system according to a variety of algorithms and accessed by an operating system as if it were a single disk. For example, data may be mirrored to multiple disks in the RAID storage system, or may be sliced and distributed across multiple disks in a number of techniques. If a small number of disks in the RAID storage system fail or become unavailable, error correction techniques may be used to recreate the missing data based on the remaining portions of the data from the other disks in the RAID storage system. The disks in the RAID storage system may be, but are not limited to, individual storage systems such storage system 600, and may be located in close proximity to each other or distributed more widely for increased security. In a write operation, write data is provided to a controller, which stores the write data across the disks, for example by mirroring or by striping the write data. In a read operation, the controller retrieves the data from the disks. The controller then yields the resulting read data as if the RAID storage system were a single disk.

Turning to FIG. 7, a wireless communication system 700 or data transmission device including a transmitter 702 with a multi-write bit-fill FIFO is shown in accordance with some embodiments of the present inventions. Communication system 700 includes a transmitter 702 that is operable to transmit encoded information via a transfer medium 706 as is known in the art. The encoded data is received from transfer medium 706 by receiver 704. Transmitter 702 incorporates a multi-write bit-fill FIFO. Such a multi-write bit-fill FIFO may be implemented consistent with that disclosed above in relation to FIGS. 3-4.

It should be noted that the various blocks discussed in the above application may be implemented in integrated circuits along with other functionality. Such integrated circuits may include all of the functions of a given block, system or circuit, or a portion of the functions of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

In conclusion, the present invention provides novel apparatuses, systems, and methods for a multi-write bit-fill FIFO. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A first-in-first-out memory comprising:
a memory circuit having an array of bit locations;
a word write pointer operable to identify a current row in the memory circuit having at least one free bit location;
a bit write pointer operable to identify a first free bit location in the current row in the memory circuit;
a first data generator operable to derive a first data word to be stored in the current row based on an input data block and any existing data in the current row; and
a second data generator operable to derive at least one second data word to be stored in subsequent rows based on the input data block.

2. The first-in-first-out memory of claim 1, further comprising a read pointer operable to identify a row address of a next row to be read from the memory circuit.

3. The first-in-first-out memory of claim 1, further comprising a fixed-width output.

4. The first-in-first-out memory of claim 1, further comprising an input width signal operable to enable the second data generator to calculate a number of full rows in the memory circuit needed to store the input data block.

5. The first-in-first-out memory of claim 1, further comprising an input data conditioner operable to normalize a number of bits in an input signal carrying the input data block to a maximum width to yield a normalized input signal carrying the input data block.

6. The first-in-first-out memory of claim 5, wherein the input data conditioner is further operable to zero-pad the normalized input signal at a least significant bit end.

7. The first-in-first-out memory of claim 1, wherein the second data generator is operable to update the word write pointer and the bit write pointer after a write operation to identify a new current row and a next free bit location in the memory circuit.

8. The first-in-first-out memory of claim 1, wherein the first-in-first-out memory is implemented as an integrated circuit.

9. The first-in-first-out memory of claim 1, wherein the first-in-first-out memory is incorporated in a storage device.

10. The first-in-first-out memory of claim 1, wherein the first-in-first-out memory is incorporated in a storage system comprising a redundant array of independent disks.

11. The first-in-first-out memory of claim 1, wherein the first-in-first-out memory is incorporated in a transmission system.

12. A method for buffering data in a first-in-first-out memory comprising:
identifying a first free bit position in a current row in the memory using a bit pointer and a word pointer;
calculating a number of bits that can fit in the current row;
deriving a first group of data bits from an input data block, where the first group of data bits contains the calculated number of bits;
storing the first group of data bits in the current row, beginning at the first free bit position;
storing a remainder of the input data block in subsequent rows in the memory; and
updating the bit pointer and the word pointer to indicate a next free bit position in the memory after the input data block.

13. The method of claim 12, wherein the number of bits that can fit in the current row is calculated by subtracting the bit pointer from a width of the memory.

14. The method of claim 12, wherein the first group of data bits is derived by right shifting the input data block by the number of bits that can fit in the current row to yield a shifted input data block and by concatenating the shifted input data block to existing data bits in the current row.

15. The method of claim 12, further comprising calculating a number of full rows that will be filled in the memory by the input data block.

16. The method of claim 12, further comprising zero-filling unused bit positions in a last row to be written in the memory for the input data block.

17. The method of claim 12, wherein the input data block has a variable width, further comprising normalizing the variable width of the input data block to a maximum width to yield a fixed-width input data block.

18. The method of claim 17, further comprising zero-padding the fixed-width input data block.

19. The method of claim 17, further comprising adjusting a width indicator identifying a number of valid data bits in the input data block by a difference between a length of the variable width and the maximum width.

20. A storage system comprising:
a storage medium maintaining a data set;
a read/write head assembly operable to write the data set to the storage medium and to provide an analog output corresponding to the data set;
a plurality of data encoders operable to prepare the data set for writing by the read/write head assembly; and
a first-in-first-out memory operable to convert a variable length data word from one of the plurality of data encoders to a fixed-length data word for a subsequent one of the plurality of data encoders, wherein the first-in-first-out memory comprises a row pointer and a column pointer for write operations identifying a next free bit space to be used for the write operations.
